(19) United States
(12) Patent Application Publication
(10) Pub. No.: US 2021/0363039 A1
(43) Pub. Date: Nov. 25, 2021

(54) Preparation Method and Application of External Carbon Source by Denitrification from Lake Algae

(71) Applicant: Jiangnan University, Wuxi (CN)

(72) Inventors: Mingxing ZHAO, Wuxi (CN); Ziyang LI, Wuxi (CN); Wansheng SHI, Wuxi (CN); Wenquan RUAN, Wuxi (CN)

(21) Appl. No.: 17/393,574

(22) Filed: Aug. 4, 2021

Related U.S. Application Data
(63) Continuation of application No. PCT/CN2020/109661, filed on Aug. 18, 2020.

(30) Foreign Application Priority Data
Aug. 27, 2019 (CN) 2019107942251

(51) Int. Cl. C02F 3/28; C02F 1/66; C02F 1/52

(52) U.S. Cl. CPC C02F 3/28; C02F 2101/105; C02F 1/5254; C02F 1/66

(57) ABSTRACT

The disclosure discloses a preparation method and application of an external carbon source for denitrification from lake algae, and belongs to the technical field of solid organic waste treatment and utilization and water treatment. According to the disclosure, a combined process of struvite precipitation+calcium phosphate precipitation is used to recover nitrogen and phosphorus from an anaerobic fermentation liquor of the lake algae, and the treated anaerobic fermentation liquor of the lake algae can replace traditional commercial carbon sources as the external carbon source in a process of nitrogen removal. The treated anaerobic fermentation liquor of the lake algae cannot only provide the carbon source for a denitrification process, but also significantly improve nitrogen removal capacity of sewage compared with the commercial carbon sources. Not only is resource utilization of the lake algae realized, but also the problem of insufficient carbon sources in urban sewage treatment plants is solved, the operation cost of the urban sewage treatment plants is reduced, and “waste” is turned into “wealth”, killing two birds with one stone.

### TECHNICAL FIELD

The disclosure herein relates to a method and application of an external carbon source for denitrification from lake algae, in particular to a technology of recovering nitrogen and phosphorus in an anaerobic fermentation liquor of the lake algae as the external carbon source, and belongs to the technical field of solid organic waste treatment and utilization and water treatment.

### BACKGROUND

In recent decades, with the acceleration of China's industrialization and the rapid development of society and economy, a large amount of wastewater containing nitrogen and phosphorus has been discharged into the water body, making the Taihu Lake, one of the freshwater lakes in China, at the eutrophication level. The eutrophication of the lake causes a massive bloom of lake algae, which threatens drinking water safety, destroys the ecological environment and natural landscape, and causes great environmental problems. The treatment, disposal and resource utilization of the lake algae in the Taihu Lake have become an urgent problem to be solved. At present, utilization methods of the lake algae at home and abroad mainly include extracting useful substances, making biodiesel, producing biogas and making organic fertilizers, but the products have low added value, so it is necessary to develop a lake algae resource utilization technology with higher added value. The lake algae have high organic matter content and are ideal substrates for anaerobic fermentation. The organic matter in the lake algae can be converted into volatile fatty acids (VFAs) through anaerobic fermentation, and the products with economic value can be obtained, so that the resource utilization of the lake algae is achieved. However, the further utilization of anaerobic fermentation products of the lake algae still needs to be further studied.

The nitrogen removal of sewage is one of the key factors to meet the increasing sewage discharge standards. However, in many Chinese cities, the lack of available carbon sources in domestic sewage seriously restricts the effective nitrogen removal. Urban sewage treatment plants usually add commercial external carbon sources (methanol, acetic acid, sodium acetate, ethanol, etc., which are materials capable of providing a carbon source by external adding) to meet the required C/N ratio of nitrogen removal, and then make it meet the sewage discharge standards through biological nitrogen removal treatment. However, the addition of the commercial carbon sources greatly increases the operating cost of the urban sewage treatment plants, so it is necessary to find suitable alternative carbon sources. In some studies, cellulose solid carbon sources such as ginkgo leaves, camphor leaves, calamus, reed flowers, straw, wood chips, bark, pine twigs and peanut shells have been used as alternative carbon sources. However, when using such carbon sources, firstly, pretreatment is needed, and the operation process is complicated; secondly, some carbon sources have a poor nitrogen removal effect, such as the bark and reed flowers, of which nitrogen removal rates are only 12.94% and 66.11%; and in addition, compared with liquid carbon sources, the solid alternative carbon sources lose advantages of being easy to use, fast in reaction speed and the like.

A struvite (magnesium ammonium phosphate, MgNH₄PO₄.6H₂O) precipitation method can simultaneously recover N and P in lake algae fermentation products, the reaction is rapid, the operation is simple, and struvite can also be directly or indirectly used as a high quality agricultural and forestry fertilizer, being a high quality slow-release fertilizer. Because of its good economic and environmental benefits, the struvite precipitation method has a broad application prospect, and is currently a research hotspot in sewage nitrogen and phosphorus removal for resource utilization.

A calcium phosphate precipitation (CP) method is a main process of phosphorus recovery at present. Calcium phosphate is a main component of phosphate ores, and the recovered calcium phosphate can be directly used as industrial raw materials of phosphates.

### SUMMARY

In order to further enhance the value of an anaerobic fermentation liquor of lake algae and reduce the application of commercial carbon sources, the disclosure provides a method and application of recovering nitrogen and phosphorus in a fermentation liquor of lake algae and using them as an external carbon source. According to the disclosure, a combined process of struvite precipitation+calcium phosphate precipitation is used to recover the nitrogen and phosphorus from the anaerobic fermentation liquor of the lake algae, and the treated anaerobic fermentation liquor of the lake algae can replace traditional commercial carbon sources as the external carbon source in the process of nitrogen removal and can obviously improve the nitrogen removal capacity of sewage compared with the commercial carbon sources.

Firstly, the disclosure provides a preparation method of an external carbon source from a fermentation liquor of lake algae, and the preparation method includes the following steps:

(1) adjusting pH of the anaerobic fermentation liquor of the lake algae to 8-11, and adding a phosphorus source and a magnesium source, wherein molar ratios of phosphorus/nitrogen P/N and magnesium/nitrogen Mg/N are 0.8-1.4 and 0.8-1.8 respectively, and precipitating for 30-60 min; and

(2) after the precipitation, conducting solid-liquid separation to obtain a supernatant, adjusting pH of the supernatant to 8-11, and adding a calcium source, wherein a molar ratio of calcium/nitrogen Ca/P is 1.67-10.02, and precipitating for 15-30 min.

The external carbon source is a material capable of providing a carbon source by external adding.

In an embodiment of the disclosure, the phosphorus source is one or more of potassium dihydrogen phosphate, dipotassium hydrogen phosphate or sodium dihydrogen phosphate; and the magnesium source is one or two of magnesium chloride or magnesium sulfate.

In an embodiment of the disclosure, the calcium source is one or two of calcium chloride or calcium sulfate.

In an embodiment of the disclosure, mechanical stirring is required in the process of precipitation, and a stirring rate is 300-400 rpm.

In an embodiment of the disclosure, in step (2), the solid-liquid separation is filtration or centrifugal separation.

In an embodiment of the disclosure, the anaerobic fermentation liquor of the lake algae is generated through anaerobic acid production and fermentation of the lake algae.

In an embodiment of the disclosure, a generation method of the anaerobic fermentation liquor of the lake algae preferably includes: treating the salvaged lake algae in a hot alkali solution with pH=12-13 and a temperature of 105-115° C. for 2-3 h, then adding anaerobic granular sludge heat-pretreated at 105-120° C. for 2-3 h into the above treated lake algae for anaerobic fermentation and acid production, and after the fermentation, conducting solid-liquid separation to take the supernatant to obtain an anaerobic acid-producing fermentation liquor of the lake algae, wherein a mass ratio of the anaerobic granular sludge to a pretreatment liquor of the lake algae is 1-2:5.

In an embodiment of the disclosure, the alkali is preferably NaOH.

In an embodiment of the disclosure, fermentation time of the anaerobic fermentation and acid production is 5-20 days.

Secondly, the disclosure further provides an external carbon source prepared by the above method.

Thirdly, the disclosure further provides application of the above external carbon source in nitrogen removal treatment, and the nitrogen removal treatment includes a denitrification or total nitrogen removal treatment process.

Finally, the disclosure provides a denitrification nitrogen removal method for domestic sewage, and the method takes the above external carbon source as a carbon source.

In an embodiment of the disclosure, the method specifically includes the following steps: mixing the domestic sewage and activated sludge for denitrification nitrogen removal; and adding the external carbon source into a reaction system with a dosage of 50-55 mg COD/L, wherein a concentration of mixed liquor suspended solids (MLSS) of the reaction system is 3000-3500 mg/L, and pH is 7.0-7.5.

In an embodiment of the disclosure, a reaction temperature of a denitrification nitrogen removal system is 35-37° C.

In an embodiment of the disclosure, the denitrification nitrogen removal requires mechanical stirring, and a stirring rate is 130-150 rpm.

In an embodiment of the disclosure, denitrification nitrogen removal time is 0-360 min (greater than 0 and less than or equal to 360 min).

### Beneficial Effects

(1) According to the disclosure, a struvite precipitation method+a calcium phosphate precipitation method are used to recover the nitrogen and phosphorus from anaerobic fermentation products of the lake algae, struvite precipitation is a chemical reaction process, the reaction is carried out at a room temperature, the reaction time is short, the reaction is rapid, the operation is convenient, and struvite formed through precipitation can be directly or indirectly used as a high quality agricultural and forestry fertilizer, being a high quality slow-release fertilizer; and calcium phosphate is a main component of phosphate ores, and the recovered calcium phosphate can be directly used as industrial raw materials of phosphates.

(2) The anaerobic acid-producing fermentation liquor of the lake algae contains a large amount of VFAs, which are bio-available carbon sources. According to the disclosure, the treated anaerobic acid-producing fermentation liquor of the lake algae is used as the carbon source for the denitrification nitrogen removal of the domestic sewage, and the nitrogen removal efficiency is significantly improved.

(3) According to the disclosure, a product of the anaerobic fermentation and acid production of the lake algae is used as the carbon source for the denitrification nitrogen removal, not only is the resource utilization of the lake algae realized, but also the problem of insufficient carbon sources in urban sewage treatment plants is solved, the operation cost of the urban sewage treatment plants is reduced, and “waste” is turned into “wealth”, killing two birds with one stone.

### BRIEF DESCRIPTION OF FIGURES

FIG. 1 is a process flow diagram of the disclosure.

FIG. 2 shows influence of pH on recovery of ammonia nitrogen in a fermentation liquor of lake algae through struvite precipitation.

FIG. 3 shows influence of a molar ratio of Mg to N on recovery of ammonia nitrogen in a fermentation liquor of lake algae through struvite.

FIG. 4 shows influence of a molar ratio of P to N on recovery of ammonia nitrogen in a fermentation liquor of lake algae through struvite.

FIG. 5 shows influence of pH on recovery of residual phosphorus in a fermentation liquor of lake algae through calcium phosphate.

FIG. 6 shows influence of a molar ratio of Ca to P on recovery of residual phosphorus in a fermentation liquor of lake algae through calcium phosphate.

FIG. 7 shows a removal effect of nitrate nitrogen using a fermentation liquor of lake algae as a carbon source for denitrification of domestic sewage.

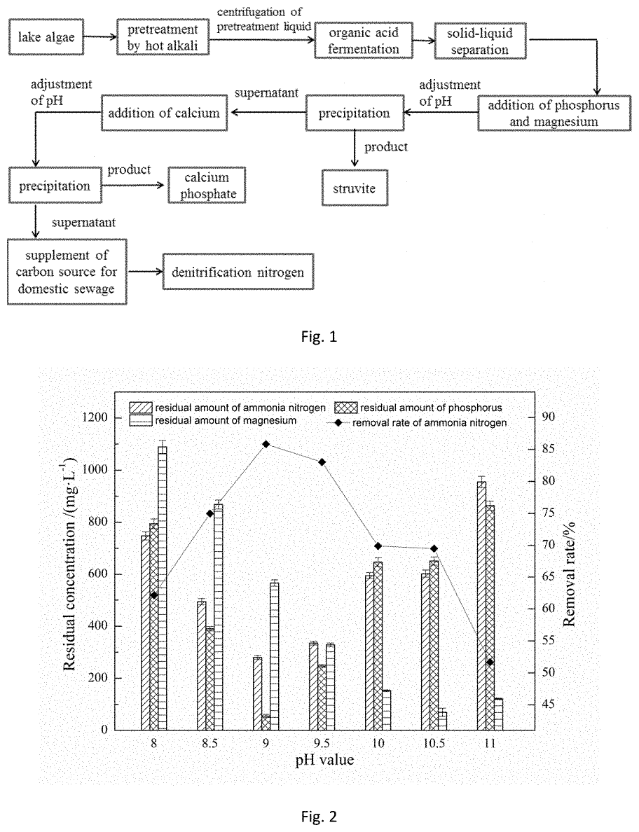

### DETAILED DESCRIPTION

### Example 1: Anaerobic Fermentation and Acid Production of Lake Algae

In the example, lake algae pretreated by hot alkali are mixed with anaerobic granular sludge to conduct anaerobic fermentation and acid production. Specific implementation steps are as follows:

The lake algae were pretreated by the hot alkali (pH was 12, temperature was 105° C., and time was 2 h) to obtain a pretreatment liquor of the lake algae. A 500 mL reaction flask was added with 300 mL of the pretreatment liquor of the lake algae, and seed mud was added according to a mass ratio of 1:5 to a substrate. The reaction flask was purged with high purity nitrogen for 5 min to maintain an anaerobic environment. The reaction was carried out in a shaker at 37° C. and 130 rpm, and the fermentation time was 10 d. After centrifugation (8000 rpm, 10 min) of a fermentation mixture, a supernatant was taken and placed in a refrigerator at 4° C. for later use. The properties of an anaerobic acid-producing fermentation liquor of the lake algae are shown in Table 1.

In the anaerobic acid-producing fermentation liquor of the lake algae, a content of volatile fatty acids is as high as 28413 mg·L⁻¹, and a ratio of VFAs to COD is 77.55%. Contents of NH₄⁺-N and water-soluble phosphorus (PO₄³⁻-P) are 2790.54 mg·L⁻¹ and 50.16 mg·L⁻¹ respectively, and the ratio of COD/TN is 10.08.

TABLE 1
Properties of anaerobic acid-producing fermentation liquor of lake algae

| Parameter | COD | NH₄⁺—N | TN | PO₄³⁻—P | TP | Protein | VFAs |
|---|---|---|---|---|---|---|---|
| Concentration (mg · L⁻¹) | 36640 | 1974.59 | 2821.1 | 50.16 | 62.77 | 5448.28 | 28413 |

### Example 2: Influence of Different pH Values on Recovery of Ammonia Nitrogen in an Anaerobic Acid-Producing Fermentation Liquor of Lake Algae Through a Struvite Precipitation Method

200 mL of the anaerobic acid-producing fermentation liquor of the lake algae was placed into a 500 mL beaker, potassium dihydrogen phosphate and magnesium chloride hexahydrate were added to make a molar ratio of Mg/P/N be 1/1/1, a 6 M sodium hydroxide solution was used to adjust pH of the solution, and the pH values were adjusted to 8, 8.5, 9, 9.5, 10, 10.5 and 11 respectively. A magnetic stirrer was used to stir at 300 rpm, the reaction was conducted for 30 min, still standing was conducted for 30 min, and supernatants were taken to measure indicators.

FIG. 2 shows effects of recovery of ammonia nitrogen in the fermentation liquor of the lake algae through the struvite precipitation method under different pH values. It can be seen that with the increase of pH, a removal rate of the ammonia nitrogen increases firstly and then decreases. When pH increases from 8 to 9, the removal rate of the ammonia nitrogen increases from 62.12% to 85.84%. When the pH continues to increase, the removal rate of the ammonia nitrogen gradually decreases from 85.84% to 51.67%. Therefore, the optimal pH value determined by the disclosure is 9.

### Example 3: Influence of Different Molar Ratios of Mg to N on Recovery of Ammonia Nitrogen in an Anaerobic Acid-Producing Fermentation Liquor of Lake Algae Through Struvite

Referring to the operating steps of Example 2, a 6 M sodium hydroxide solution was used to adjust pH of a solution to 9, and a dosage of potassium dihydrogen phosphate was fixed. A molar ratio of P/N was 1/1, a dosage of magnesium chloride hexahydrate was changed, and reactions were conducted under conditions that the molar ratios of Mg/N were 0.8/1, 1/1, 1.1/1, 1.2/1, 1.4/1, 1.6/1 and 1.8/1 respectively. A magnetic stirrer was used to stir at 300 rpm, the reaction was conducted for 30 min, still standing was conducted for 30 min, and supernatants were taken to measure indicators.

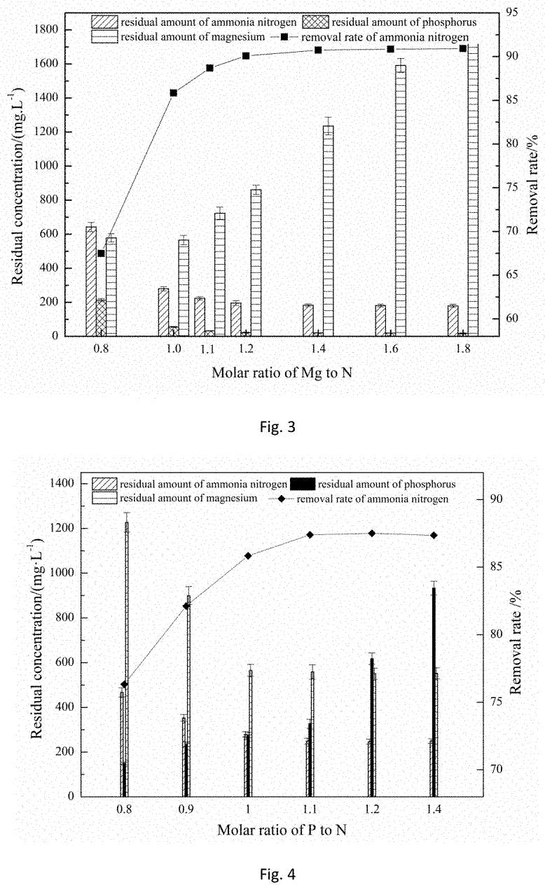

FIG. 3 shows effects of recovery of ammonia nitrogen in the anaerobic acid-producing fermentation liquor of the lake algae through the struvite precipitation under different molar ratios of Mg to N. It can be seen that with the increase of the molar ratios of Mg to N, a removal rate of the ammonia nitrogen increases significantly. When the molar ratio of Mg/N increases from 0.8/1 to 1.2/1, the removal rate of the ammonia nitrogen increases from 67.48% to 90.08%. When the molar ratio of Mg/N continues to increase, the removal rate of the ammonia nitrogen does not increase significantly. When the molar ratio of Mg/N is 1.8/1, the removal rate of the ammonia nitrogen is 90.91%. Compared with the molar ratio of Mg/N of 0.8/1, the removal rate of the ammonia nitrogen only increases by 0.83%. Since increasing the molar ratio of Mg/N will increase the dosage of the magnesium chloride hexahydrate accordingly, considering the economy, the disclosure suggests that the molar ratio of Mg/N should be 1.2/1 in the actual operation.

### Example 4: Influence of Different Molar Ratios of P to N on Recovery of Ammonia Nitrogen in an Anaerobic Acid-Producing Fermentation Liquor of Lake Algae Through Struvite

Referring to the operating steps of Examples 1 and 2, a 6 M sodium hydroxide solution was used to adjust pH of a solution to 9, and a dosage of magnesium chloride hexahydrate was fixed. A molar ratio of Mg/N was 1.2/1, a dosage of potassium dihydrogen phosphate was changed, and reactions were conducted under conditions that the molar ratios of P/N were 0.8/1, 0.9/1, 1/1, 1.1/1, 1.2/1 and 1.4/1 respectively. A magnetic stirrer was used to stir at 300 rpm, the reaction was conducted for 30 min, still standing was conducted for 30 min, and supernatants were taken to measure indicators.

FIG. 4 shows effects of recovery of ammonia nitrogen in the anaerobic acid-producing fermentation liquor of the lake algae through the struvite precipitation under different molar ratios of P to N. It can be seen that with the increase of the molar ratios of P to N, a removal rate of the ammonia nitrogen increases significantly. When the molar ratio of P/N increases from 0.8/1 to 1.1/1, the removal rate of the ammonia nitrogen increases from 76.33% to 87.39%. When the molar ratio of P/N continues to increase, the removal rate of the ammonia nitrogen does not increase significantly. Since increasing the molar ratio of P/N will increase the dosage of the potassium dihydrogen phosphate accordingly, considering the economy, the disclosure suggests that the molar ratio of P/N should be 1.1/1 in the actual operation.

### Example 5: Influence of Different pH Values on Recovery of Residual Phosphorus in an Anaerobic Acid-Producing Fermentation Liquor of Lake Algae Through a Calcium Phosphate Precipitation Method

200 mL of the anaerobic acid-producing fermentation liquor of the lake algae treated by a struvite precipitation method was placed in a 500 mL beaker (pH during struvite precipitation was 9, a molar ratio of Mg/N was 1.2/1, and a molar ratio of P/N was 1.1/1). Calcium chloride dihydrate was added to make a molar ratio of Ca/P be 1.67/1. A 6 M sodium hydroxide solution was used to adjust pH of the solution, and reactions were conducted under conditions that the pH values were 8, 8.5, 9, 9.5, 10, 10.5 and 11 respectively. A magnetic stirrer was used to stir at 300 rpm, the reaction was conducted for 15 min, still standing was conducted for 30 min, and supernatants were taken to measure indicators.

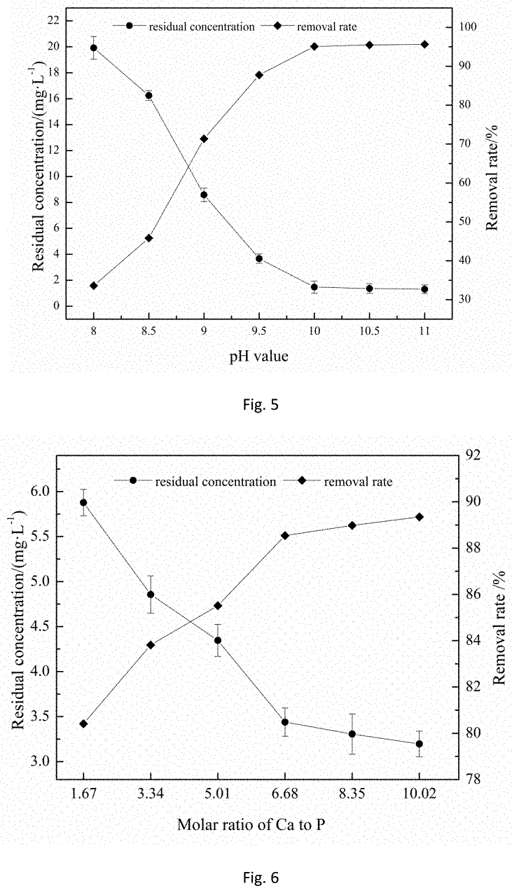

FIG. 5 shows effects of recovery of residual phosphorus in the anaerobic acid-producing fermentation liquor of the lake algae through the calcium phosphate precipitation method under different pH values. It can be seen that with the increase of the pH value, a removal rate of the phosphorus increases significantly. When the pH value increases from 8 to 10, the removal rate of the phosphorus increases from 33.6% to 95.1%. When the pH value continues to increase, the removal rate of the phosphorus does not increase significantly. When the pH value is 11, the removal rate of the phosphorus is 95.63%, with an increase of only 0.53%. Since increasing the pH will consume more sodium hydroxide, from the perspective of economy, the disclosure suggests that the pH value should be 10 in the actual operation.

### Example 6: Influence of Different Molar Ratios of Ca to P on Recovery of Residual Phosphorus in an Anaerobic Acid-Producing Fermentation Liquor of Lake Algae Through a Calcium Phosphate Precipitation Method

Referring to the operating steps of Example 5, a 6 M sodium hydroxide solution was used to adjust pH of a solution to 10, calcium chloride dihydrate was added, and reactions were conducted under conditions that the molar ratios of Ca/P were 1.67/1, 3.34/1, 5.01/1, 6.68/1, 8.35/1 and 10.02/1 respectively. A magnetic stirrer was used to stir at 300 rpm, the reaction was conducted for 15 min, still standing was conducted for 30 min, and supernatants were taken to measure indicators.

FIG. 6 shows effects of recovery of residual phosphorus in the anaerobic acid-producing fermentation liquor of the lake algae through the calcium phosphate precipitation method under different molar ratios of Ca to P. It can be seen that with the increase of the molar ratio of Ca to P, a removal rate of the phosphorus increases significantly. When the molar ratio of Ca to P increases from 1.67 to 6.68, the removal rate of the phosphorus increases from 80.41% to 88.54%. When the molar ratio of Ca to P continues to increase, the increasing of the removal rate of the phosphorus is smaller. When the molar ratio of Ca to P is 10.02, the removal rate of the phosphorus is 89.35%, with an increase of only 0.81%. Since more calcium chloride dihydrate needs to be added for the molar ratio of Ca to P, from the perspective of economy, the disclosure suggests that the molar ratio of Ca to P should be 6.68 in the actual operation.

### Example 7: Effect of Recovery of Nitrogen and Phosphorus in an Anaerobic Acid-Producing Fermentation Liquor of Lake Algae Through a Combined Process Under an Optimal Condition

Referring to Examples 3, 4 and 5, an optimal process condition of a struvite precipitation method is that pH is 9, and a molar ratio of Mg/P/N is 1.2/1.1/1. Referring to Examples 5 and 6, an optimal process condition of a calcium phosphate precipitation method is that pH is 10, and a molar ratio of Ca/P is 6.68. The effect of recovery of ammonia nitrogen in the anaerobic acid-producing fermentation liquor of the lake algae through the combined process under the optimal condition is shown in Table 2.

Ammonia nitrogen (NH₄⁺-N), water-soluble phosphorus (SOP), TN and TP decrease from 1974.59 mg·L⁻¹, 50.16 mg·L⁻¹, 2821.1 mg·L⁻¹ and 62.77 mg·L⁻¹ to 22.83 mg·L⁻¹, 2.7 mg·L⁻¹, 550.16 mg·L⁻¹ and 8.02 mg·L⁻¹ respectively, and removal rates are 98.84%, 94.62%, 80.5% and 87.22% respectively.

TABLE 2
Effect of recovery of nitrogen and phosphorus in
anaerobic acid-producing fermentation liquor of lake
algae through combined process under optimal condition

| | | | After calcium | |
|---|---|---|---|---|
| | Initial mass | After struvite | phosphate | |
| | concentration | precipitation | precipitation | Removal |
| Parameter | (mg · L⁻¹) | (mg · L⁻¹) | (mg · L⁻¹) | rate/% |
| COD | 36640 | 33040 | 29920 | 18.34 |
| NH₄⁺—N | 1974.59 | 26.93 | 22.83 | 98.84 |
| TN | 2821.1 | 583.33 | 550.16 | 80.5 |
| SOP | 50.16 | 30 | 2.7 | 94.62 |
| TP | 62.77 | 34.32 | 8.02 | 87.22 |
| Protein | 5448.28 | 3827.59 | 3586.21 | 34.18 |
| Acetic acid | 12800 | 11160 | 10500 | 17.97 |
| Propionic acid | 3000 | 2265 | 2038 | 32.07 |
| Butyric acid | 7062 | 6297 | 5678 | 19.6 |
| Isobutyric acid | 2384 | 2202 | 1674 | 29.78 |
| Pentanoic acid | 714 | 816 | 510 | 28.57 |
| Caproic acid | 2453 | 2232 | 1768 | 27.92 |
| VFAs | 28413 | 24973 | 22168 | 21.98 |

### Example 8: Removal Effect of Nitrate Nitrogen Using a Treated Anaerobic Acid-Producing Fermentation Liquor of Lake Algae as a Denitrification External Carbon Source of Domestic Sewage

In the example, the domestic sewage and activated sludge were mixed for denitrification nitrogen removal, potassium nitrate was added into the domestic sewage to make an initial concentration of NO₃⁻-N be 30 mg·L⁻¹, and a concentration of mixed liquor suspended solids (MLSS) of a reaction system was 3000 mg/L. pH was adjusted to 7.0±0.5, water bath heating was conducted at 35±0.1° C., and mechanical stirring was conducted to make it fully mixed. With no external carbon source as a blank group, ethanol and the anaerobic acid-producing fermentation liquor of the lake algae after nitrogen and phosphorus recovery prepared in Example 7 were respectively added as carbon sources, and the amount of the external carbon source was 50 mg COD·L⁻¹ (that is, the external carbon source was added, so that in the final reaction system, the concentration of COD provided by the external carbon source was 50 mg COD·L⁻¹), denitrification effects were compared, and changes of the nitrate nitrogen were measured by interval sampling. Properties of the domestic sewage for the experiment are shown in Table 3.

TABLE 3
Properties of domestic sewage for experiment

| Parameter | COD | NH₄⁺—N | NO₃⁻—N | NO₂⁻—N | TP |
|---|---|---|---|---|---|
| Concentration (mg · L⁻¹) | 78 | 11.22 | 30 | 0.17 | 3.18 |

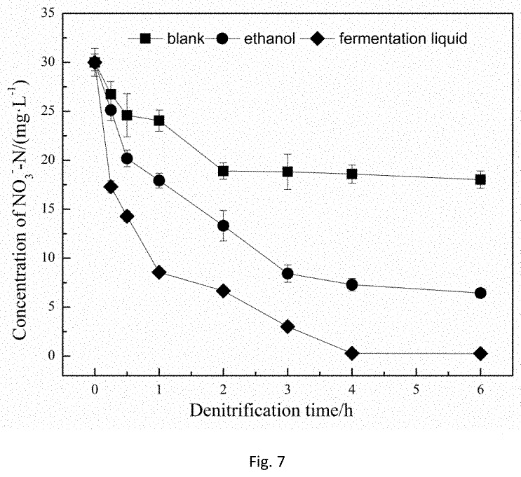

FIG. 7 shows a removal effect of nitrate nitrogen using the anaerobic acid-producing fermentation liquor of the lake algae after the nitrogen and phosphorus recovery as the carbon source for the denitrification of the domestic sewage. It can be seen that when the anaerobic acid-producing fermentation liquor of the lake algae after the nitrogen and phosphorus recovery is used as the carbon source for the denitrification, the concentration of NO₃⁻N in the domestic sewage decreases from the initial 30 mg·L⁻¹ to 0.26 mg·L⁻¹, with a removal rate of 99.13%, and NO₃⁻-N is basically completely removed. When the ethanol is used as the external carbon source, the removal rate of NO₃⁻-N is 78.53%. When no external carbon source is added, the removal rate of NO₃⁻-N is only 39.94%. It can be found that when the anaerobic acid-producing fermentation liquor of the lake algae after the nitrogen and phosphorus recovery is used as the carbon source for the denitrification, the removal rates of NO₃⁻-N increase by 59.19% and 20.6% respectively, compared with no external carbon source and using the ethanol as the carbon source, indicating that the fermentation liquor of the lake algae is rich in bio-available carbon sources, and can be used as the carbon source for enhancing denitrification nitrogen removal.

### Comparative Example 1

Effect situation of an anaerobic acid-producing fermentation liquor of lake algae treated through struvite alone as an external carbon source for denitrification

The anaerobic acid-producing fermentation liquor of the lake algae was treated only through struvite precipitation (a precipitation process was that pH was 9, and a molar ratio of Mg/P/N was 1.2/1.1/1) to obtain a fermentation liquor, the fermentation liquor was used as the external carbon source for the denitrification of domestic sewage, the denitrification treatment of the domestic sewage was carried out according to the method of Example 8, and comparative analysis was made. It can be found that when the anaerobic acid-producing fermentation liquor of the lake algae treated only through the struvite precipitation is used as the carbon source of the denitrification, a concentration of NO₃⁻-N in the domestic sewage decreases from the initial 30 mg·L⁻¹ to 6.9 mg·L⁻¹, and a removal rate is 77.0%. Compared with using the anaerobic acid-producing fermentation liquor of the lake algae adopting a combination of struvite+calcium phosphate for removal as the external carbon source (99.13%), the removal rate of NO₃⁻-N decreases by 22.32%.

### Comparative Example 2

Effect situation of an anaerobic acid-producing fermentation liquor of lake algae treated through calcium phosphate alone as an external carbon source for denitrification

The anaerobic acid-producing fermentation liquor of the lake algae was treated only through calcium phosphate precipitation (a precipitation process was that pH was 10, and a molar ratio of Ca/P was 6.68) to obtain a fermentation liquor, the fermentation liquor was used as the external carbon source for the denitrification of domestic sewage, the denitrification treatment of the domestic sewage was carried out according to the method of Example 8, and comparative analysis was made. It can be found that when the anaerobic acid-producing fermentation liquor of the lake algae treated only through the calcium phosphate precipitation is used as the carbon source of the denitrification, a concentration of NO₃⁻-N in the domestic sewage decreases from the initial 30 mg·L⁻¹ to 9.4 mg·L⁻¹, and a removal rate is 68.7%. Compared with using the anaerobic acid-producing fermentation liquor of the lake algae adopting a combination of struvite+calcium phosphate for removal as the external carbon source (99.13%), the removal rate of NO₃⁻-N decreases by 30.7%.

What is claimed is:

1. A preparation method of an external carbon source, wherein the method comprises the following steps:
(1) adjusting pH of an anaerobic fermentation liquor of lake algae to 8-11, and adding a phosphorus source and a magnesium source, wherein molar ratios of phosphorus/nitrogen and magnesium/nitrogen are 0.8-1.4 and 0.8-1.8 respectively, and precipitating for 30-60 min; and
(2) after the precipitation, conducting solid-liquid separation to obtain a supernatant, adjusting pH of the supernatant to 8-11, and adding a calcium source, wherein a molar ratio of calcium/phosphorus is 1.67-10.02, and precipitating for 15-30 min;
wherein the external carbon source is a material capable of providing a carbon source by external addition.

2. The preparation method of claim 1, wherein the phosphorus source is one or more of potassium dihydrogen phosphate, dipotassium hydrogen phosphate or sodium dihydrogen phosphate; and the magnesium source is one or more of magnesium chloride or magnesium sulfate.

3. The preparation method of claim 1, wherein the calcium source is one or more of calcium chloride or calcium sulfate.

4. The preparation method of claim 1, wherein a generation method of the anaerobic fermentation liquor of the lake algae comprises: treating salvaged lake algae in a hot alkali solution with pH of 12-13 and a temperature of 105-115° C. for 2-3 hours, then adding anaerobic granular sludge heat-pretreated at 105-120° C. for 2-3 hours into the above treated lake algae for anaerobic fermentation and acid production, and after the fermentation, conducting solid-liquid separation to take a supernatant to obtain an anaerobic acid-producing fermentation liquor of the lake algae, wherein a mass ratio of the anaerobic granular sludge to a pretreatment liquor of the lake algae is 1-2:5.

5. The preparation method of claim 3, wherein a generation method of the anaerobic fermentation liquor of the lake algae comprises: treating salvaged lake algae in a hot alkali solution with pH of 12-13 and a temperature of 105-115° C. for 2-3 hours, then adding anaerobic granular sludge heat-pretreated at 105-120° C. for 2-3 hours into the above treated lake algae for anaerobic fermentation and acid production, and after the fermentation, conducting solid-liquid separation to take a supernatant to obtain an anaerobic acid-producing fermentation liquor of the lake algae, wherein a mass ratio of the anaerobic granular sludge to a pretreatment liquor of the lake algae is 1-2:5.

6. The preparation method of claim 4, wherein the alkali is NaOH.

7. The preparation method of claim 4, wherein fermentation time of the anaerobic fermentation and acid production is 5-20 days.

8. An external carbon source prepared by the preparation method of claim 1.

9. A method of use of the external carbon source of claim 8, comprising performing a denitrification or total nitrogen removal treatment process.

10. A method of use of the external carbon source of claim 8, comprising using the external carbon source as a carbon source and performing denitrification nitrogen removal from domestic sewage.

11. The method of claim 10, wherein the method comprises the following steps: mixing the domestic sewage and activated sludge for denitrification nitrogen removal; and adding the external carbon source into a reaction system with a dosage of 50-55 mg COD/L, wherein a concentration of mixed liquor suspended solids of the reaction system is 3000-3500 mg/L, and pH is 7.0-7.5.

12. The method of claim 11, wherein a reaction temperature is 35-37° C.

13. The method of claim 12, wherein denitrification nitrogen removal time is less than or equal to 360 min.
